(19) United States
(12) Patent Application Publication
(10) Pub. No.: US 2014/0311700 A1
(43) Pub. Date: Oct. 23, 2014

(54) METHOD FOR PROCESSING OF HEAT ENERGY ABSORBED FROM THE ENVIRONMENT AND A UNIT FOR PROCESSING OF HEAT ENERGY ABSORBED FROM THE ENVIRONMENT

(71) Applicants: Ryszard Pakulski, Pozan (PL); Jaroslaw Goslinski, Poznan (PL)

(72) Inventors: Ryszard Pakulski, Pozan (PL); Jaroslaw Goslinski, Poznan (PL)

(21) Appl. No.: 14/322,795

(22) Filed: Jul. 2, 2014

Related U.S. Application Data
(63) Continuation-in-part of application No. 13/488,272, filed on Jun. 4, 2012, now abandoned.

(30) Foreign Application Priority Data
Apr. 2, 2012 (PL) P.398697

(51) Int. Cl. F28D 20/00

(52) U.S. Cl. CPC F28D 20/00
USPC 165/8

(57) ABSTRACT

The subject of the invention is a method for processing of heat energy absorbed from the environment and a unit for processing of heat energy absorbed from the environment, used for the supply of energy load points, especially electric load points, especially in places with large and frequent changes of environment temperature. The system uses an energy accumulator, which is connected to an actuating element through an energy level controller. This method is implemented in a stand-alone unit, wherein an energy level controller is placed between the energy accumulator and the actuating element.

### CROSS REFERENCE TO RELATED APPLICATIONS

This application is a continuation in part of U.S. application Ser. No. 13/488,272, filed on Jun. 4, 2012, presently pending which in turn claims the benefit of priority pursuant to 35 U.S.C. §119 and the Paris Convention, to the Polish Patent Application No. P 398697 filed Apr. 2, 2012, the contents of each application are incorporated herein by reference.

### BACKGROUND OF THE INVENTION

The subject of the invention is a method for processing of heat energy absorbed from the environment and a unit for processing of heat energy absorbed from the environment, used for the supply of energy load points, especially electric load points, especially in places with large and frequent changes of environment temperature.

The subject matter of the invention is an improvement to known methods of obtaining of energy, also electric energy, from natural sources of energy, and methods used for the transformation of natural energy in useful energy.

Humanity has, for a long time, used wind energy, transformed in various devices into driving energy for load points, such as mills and other driving force load devices. With the development of technology and the invention of electrical current, the wind energy was used to drive power generators.

The energy of water was also used, with the water flow energy driving various types of devices transforming this energy to useful energy, supplying various types of load points, and also driving electric power generators.

Solar power was also used, transformed in devices into useful energy for heating or supplying of other electric current load points.

All the listed sources of natural energy may be used only when this energy is present in a limited location, such as water-power plants, or at a limited time, like solar batteries or wind-power plants, which reduces the usefulness of its usage.

The solution used in the description GB 984268 has a filament located in an air bellows, in which it heats the air, which as a result of thermal expansion creates increased pressure, enabling the lengthening of the bellows and applying force to a moving element of the end of the bellows.

In the solution in the JP 61089975 patent, the piezoelectric phenomenon was used to move the needle powering the piston of the load point.

The system described in U.S. Pat. No. 5,822,989 presents a friction brake switch, in which the element applying pressure to disks through a bearing is a set of sockets with polymers, expanding through the phenomenon of thermal expansion.

A solution is known, presented in Polish Patent description no 210333 in which the method of transforming of heat energy from the environment, the essence of which is having an element with a high thermal expansion coefficient is connected mechanically with a moving element of an energy accumulator, which is then connected to an actuating element, which is then connected to the load point.

### BRIEF DESCRIPTION OF THE DRAWINGS

FIG. 1 is a flowchart of a one embodiment of the invention;

FIG. 2 is a flowchart of another embodiment of the invention;

FIG. 3 is a diagram of a unit for one embodiment of the invention;

FIG. 4 is a diagram of a unit for another embodiment of the invention; and

FIG. 5 is a diagram of an alternative embodiment of the invention.

### SUMMARY OF THE INVENTION

This method is realised in the unit, which consists of an element with a high thermal expansion coefficient, connected mechanically with a moving element of an energy accumulator, which is then connected to an actuating element, which is connected to the load point.

The goal of the invention is to eliminate the abovementioned defects and problems and to propose a method which enables the transformation of heat energy from the surrounding to another form of energy and a unit for the implementation of this method.

### DETAILED DESCRIPTION

The essence of the invention, which is a method of transforming of heat energy, absorbed from the environment, having an element with a high thermal expansion coefficient, connected mechanically on at least one end with a moving element of an energy accumulator, which is then connected to an actuating element, which is then connected to the load point, consists of an energy accumulator connecting to an actuating element through an energy level controller.

It is advantageous, when a mechanical controller is used as an energy level controller.

It is also advantageous, when a flow choke with outflow control is used as an energy level controller.

It is also advantageous, when a bimetallic system is used as an energy level controller.

It is also advantageous, when a multi joint flat system is used as an energy level controller.

This method is used in an unit for the transforming of heat energy, absorbed from the environment, the essence of which consists of having an element with a high thermal expansion coefficient, connected mechanically on at least one end with a moving element of an energy accumulator, which is then connected to an actuating element, wherein between the energy accumulator and the actuating element an energy level controller is placed.

It is advantageous, when the energy level controller is a mechanical controller.

It is also advantageous, when the energy level controller is a flow choke with outflow control.

It is also advantageous, when the energy level controller is an electric controller.

It is also advantageous, when the energy level controller is a bimetallic system.

It is also advantageous, when the energy level controller is a multi joint flat system.

The use of the solution presented in the invention enables the following technical and utility effects:
the ability to use heat energy drawn from the environment when the environment temperature changes and to use it into technically usable energy,
the ability to control the amount of energy transferred to the load point,
the ability to supply energy load points regardless of the time of the day and year,
maintenance-free device,
the ability to use to use in any time and place regardless of the presence of sun, wind and flowing water stream and to supply energy to any load point.

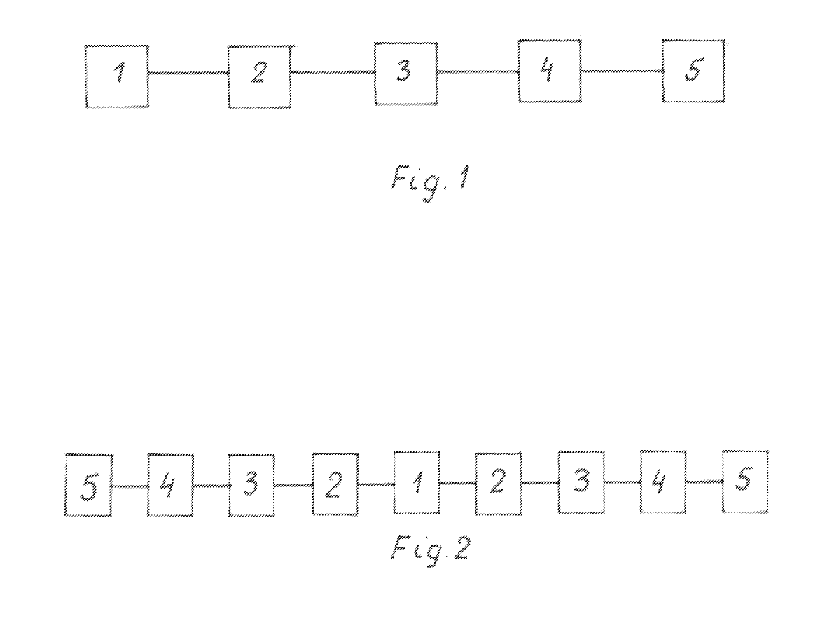

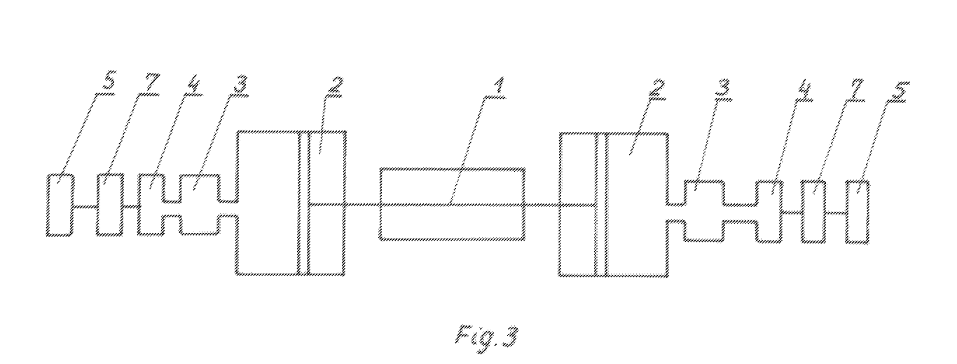

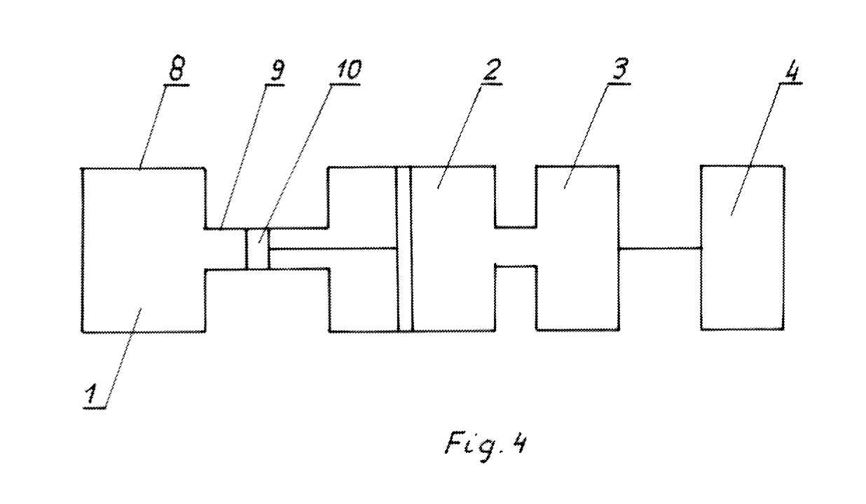

The subject of the invention in a sample implementation was described in below examples and was shown on the drawing, where on FIG. 1 a flowchart with a one-sided power draw is presented, on FIG. 2 a flowchart with a two-sided power draw is presented, on FIG. 3 a diagram of the unit for transforming the heat energy with an element with lengthwise thermal expansion direction is presented, and on FIG. 4 with an element with volumetric thermal expansion is presented.

The unit in one of the implementation versions is formed of an element 1 with a large of lengthwise thermal expansion coefficient, which is advantageously a rod. This rod is connected mechanically with a moving element of the energy accumulator 2, which is then connected by an energy level controller 3 with an actuating element 4, to which an energy load point 5 is connected. The energy accumulator 2 in one of non-limiting versions of implementation is a closed fluid tank, in which a sliding piston 6 is placed, which is the moving element of the energy accumulator 2. Energy accumulator 2 within the closed space wall has an energy level controller 3, which is a variable flow nozzle with an outlet in the turbine blades zone, forming the actuating element 4. Turbine 4 is mechanically connected with the alternator 7, which is connected with an energy load point 5, which is advantageously a battery for powering of other electric load points, not shown on the drawing.

In other implementation version the turbine 4 is connected with an alternator 7 through a mechanical transmission.

In another implementation version the element 1 has pistons 6 of energy accumulators 2 mounted on both ends, which, as in the implementations above are connected by a mechanical energy level controller 3 with actuating elements 4 and energy load points 5.

Depending on the version of implementation, the energy level controller is a a mechanical flow choke, with outflow control, electric controller, bimetallic system, or a multi-joint flat system

There are versions, presented on FIG. 4, in which element 1 is a high thermal expansion coefficient medium, advantageously gas, fluid, mercury or other medium. This medium is closed in a container 8, having a cylinder 9 with a piston 10. The piston 10 is connected with a sliding element of an energy accumulator 2, which through an electric energy level controller 3 is connected to an actuating element 4.

In a next version of implementation, not shown on the drawing, the energy accumulator 2 is a set of springs, of which one is compressed and another one is stretched. The springs are connected with the end of the element 1 and with the known element for transforming the potential energy of the spring to kinetic energy, which sends this energy to the impeller of the generator 8.

Change of the environment temperature causes the change of the length of the element 1 and movement of the piston 6. In another implementation the change of the environment temperature causes the increase of the volume of the medium 1 in the container 8 and the movement of piston 10 in the cylinder 9, and thus the movement of the piston of the energy accumulator 2. In one of the versions of the implementation the fluid contained in the energy accumulator 2 will be injected by a nozzle 3 onto the blades of the turbine 4. Turbine 4 drives the alternator 7 directly or through a mechanical transmission. The current created in the alternator 7 powers the energy load point 5.

In another version of the implementation the change of length of the element 1 causes the movement of two pistons 5 in energy accumulators 2 and causes the turbines 3 to drive two alternators 7.

To increase the clarity of the description, we have resigned to present the solution of the energy amount control systems 3 depending on the direction of the temperature gradient changes.

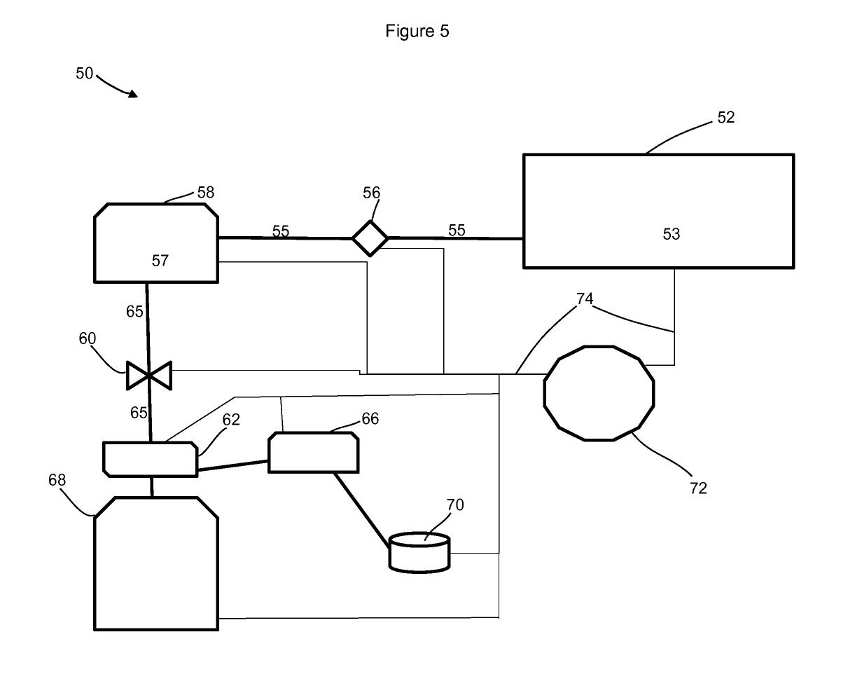

An alternative embodiment of the system 50 is shown in FIG. 5. In the alternative embodiment, the system operates by converting energy retrieved during expansion of a gas in a container. The container is initially compressed. Additional energy is provided by a second container with a liquid. The liquid expands with heat. A second gas container with gas is optional. The second gas container can be used to increase the operating range.

As depicted there, the system 50 comprises a liquid storage tank 51 containing liquid 53. In one embodiment the liquid 53 comprises any suitable heat transfer fluid such as transformer oil, however, other moieties of liquid are acceptable, so long as the liquid 53 expands with heat. It is any liquid, for which the parameters are defined as compressibility and thermal expansion. The objective is to select for such liquid coefficient of thermal expansion which is the greatest (optimization). In addition, the liquid must not be selected from substances which, under the influence high pressure, lead to self-ignition. The tank is connected via a line 55 to a pressurized liquid container 58. The line comprises a highly durable material, and is made of metal in one embodiment. The line 55 connects two environments—a predominantly liquid one and a high pressure gas one. As such, it must be highly durable.

In one embodiment, a separator 56 is added in the line to limit the exchange between the liquid storage tank 51 and the pressurized gas container 58. In one embodiment, the separator 56 is added in-line 55. In other embodiments, not shown, the separator 56 is built into the liquid storage tank 51 and/or the pressurized gas container 58.

The separator 56 is a unique device with an innovative design. The goal of the separator is to change the gas volume due to the action of the change in volume of the liquid. The separator 56 consists of a chamber divided by a membrane and a piston rod assembly made of a ceramic, in one embodiment. The assembly prevents direct contact between the liquid and the gas.

In one embodiment, the separator acts as a force multiplier. In this embodiment, the separator includes a double piston which affects the change in the volume of the gas when the volume of the liquid increases by 1 cm³. By using multiple pistons, the separator ensures that the system is highly responsive to changes in the liquid volume.

The pressurized gas container 58 contains a gas 57 comprising the constituents of air. The gas moieties are selected in order to maximize energy transfer. The gas used should be inert, especially as pressure is increased. Certain gasses become explosive in high pressure situations. The gas is selected to be as compressible as possible. Compressibility is measured as the maximum pressure achievable, including factoring for condensation and eventual liquidification of the gas after condensation.

The pressurized gas tank 58 is connected to a second pressurized gas tank 68 using a gas-tight line 65. The gas line 65 must withstand pressures of 400 Mpa, in one embodiment, however, the pressure requirements are a function of the dimensions of any one embodiment. The pressurized line 65 includes a control valve 60. The control valve 60 is used to manage the pressure differential between the two pressurized gas tanks 58, 68. At the moment when the pressure in the two tanks 58, 68 is equalized, the control valve 60 is closed. The liquid 53 returns to its original volume and the pressure in the pressurized gas container 58 decreases. When the valve is opened, the liquid 53 slightly increases its volume due to compressibility. The opening of the valve 60 occurs at the moment of maximum expansion of the liquid, which then begins the cycle and returns to the initial liquid volume.

As the pressure of the gas 57 in the pressurized gas container 58 reaches a minimum state (in one embodiment the minimum state is 0.1 to 1 Mpa). The minimum pressure is a function of the construction of the system and the scale of all elements. The control valve 60 opens and the gas 57 which had traversed the line 65 to the pressurized container 68 returns from the pressurized container 68 to the pressurized container 58. As gas 57 traverses the line 65, it drives a gas turbine 62, which is installed on a segment of the line 65. In one embodiment a single turbine is used, in another embodiment, multiple turbines 62 are installed along the line 65.

Initially, the pressurized gas container 58 is pressurized with a compressed gas 57. In one embodiment, the initial pressure of the gas is the atmospheric pressure. However, it need not be the atmospheric pressure, and is a function of the level of energy in the gas. The level of energy determines the absorption capabilities of the machine. Once the pressurized gas container 58 reaches the maximum pressure, the control valve 60 is opened and the gas 57 traverses the line 65 to the pressurized container 68.

At the start of operation, the separator 56 is in its extreme position on the right side (in the direction of the liquid). Along with the expansion of the liquid separator, located on the piston rod, the membrane of the separator moves in the direction of the gas.

The greatest amount of energy is generated by the turbine 62 during the first cycle as initially, the gas from the pressurized container 58 is highly pressurized.

In one embodiment, the turbine 62 is connected to an energy alternator 66, such as an electric motor. The energy alternator 66 converts the mechanical energy of the turbine into another form of energy, such as electric current. In one embodiment, the turbine 62 and the alternator 66 are integrated into one unit. The alternator 66, conveys electrical current to one or more loads 70. In one embodiment, the loads 70 comprise a bank of batteries.

The system also includes control logic 72 which regulates the pressures within the system. The control logic 72 opens and closes the control valve 60 in response to several factors, including the pressure in each container 58, 68, the temperature of the system 50, the rate of gas flow through the line 65 and the turbine 62 activity. The control logic 72 also includes information about the container 52 and the liquid 53 and the status of the alternator 66 and its load 70. In the embodiment shown in FIG. 5, the control logic includes physical connections 74 to the elements of the system, however, in other embodiments, in other embodiments, the control logic 72 comprises one or more wireless communications means, including Bluetooth, WIFI, and other industrial networks. The control logic 72 can comprise a specially programmed circuit or a general purpose computer with communication software capable of communicating with the various components using connections 74.

The container 52 is the storage tank to which the gas flows when the valve 60 is opened. Due to the expansion of the liquid reservoir, the gas in container 58 is compressed. Thus, after several hours in the tank 58, the pressure will be higher than the pressure in the reservoir 52 following the opening of valve 60. The opening of the valve 60 equates the pressure in the tanks. Without the container 52, the system could not cycle and would need to be reloaded after every exchange.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting, but are instead exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the terms “comprising” and “wherein.” Moreover, in the following claims, the terms “first,” “second,” and “third,” are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

The embodiment of the invention in which an exclusive property or privilege is claimed is defined as follows:

1. A method of transforming of heat energy, absorbed from the environment, comprising providing an element with a high thermal expansion coefficient, connecting said element mechanically on at least one end with a moving element of an energy accumulator, connecting the moving element to an actuating element, connecting the actuating element to a load point, wherein an energy accumulator is connected to the actuating element through an energy level controller.

2. The method in accordance with claim 1, wherein the energy level controller comprises a mechanical controller.

3. The method in accordance with claim 1, wherein the energy level controller comprises a flow choke with outflow control.

4. The method in accordance with claim 1, wherein the energy level controller comprises an electric controller.

5. The method in accordance with claim 1, wherein the energy level controller comprises an bimetallic system.

6. The method in accordance with claim 1, wherein the energy level controller comprises a multi-joint flat system.

7. A unit for transforming of heat energy, absorbed from the environment, comprising an element with a high thermal expansion coefficient, wherein said element is connected mechanically on at least one end with a moving element of an energy accumulator, wherein said accumulator is in turn connected to an actuating element, wherein the actuating element is then connected to a load point, wherein an energy level controller is located between the energy accumulator and the actuating element.

8. The unit in accordance with claim 7, wherein the energy level controller comprises a mechanical controller.

9. The unit in accordance with claim 7, wherein the energy level controller comprises a flow choke with outflow control.

10. The unit in accordance with claim 7, wherein the energy level controller comprises an electric controller.

11. The unit in accordance with claim 7, wherein the energy level controller comprises a bimetallic system.

12. The unit in accordance with claim 7, wherein the energy level controller comprises a multi-joint flat system.
